(19) United States
(12) Patent Application Publication
(10) Pub. No.: US 2013/0226766 A1
(43) Pub. Date: Aug. 29, 2013

(54) RETAIL CONTRACT MATCHING SYSTEM

(71) Applicants: Peter Behrens, London (GB); John Gillespie, London (GB); Rhydian Lewis, London (GB)

(72) Inventors: Peter Behrens, London (GB); John Gillespie, London (GB); Rhydian Lewis, London (GB)

(73) Assignee: RETAIL MONEY MARKET LTD, London (GB)

(21) Appl. No.: 13/816,060

(22) PCT Filed: Aug. 9, 2011
(86) PCT No.: PCT/AU2011/001008

§ 371 Date: May 17, 2013

(30) Foreign Application Priority Data
Aug. 11, 2010 (GB) 1013475.7

(51) Int. Cl. G06Q 40/04

(52) U.S. Cl. CPC G06Q 40/04
USPC 705/37

(57) ABSTRACT

A matching mechanism for matching entities in an exchange, the entities being based on disparate criteria, the mechanism including a first input from a first set of users adapted to submit to a processor a first criterion from a first set of criteria relevant to the first set of users, which first criterion characterises an entity to be matched. The mechanism including a second input from a second set of users adapted to submit to the processor a second criterion from a second set of criteria relevant to the second set of users, which second criterion characterises another entity to be matched, wherein the first and second criteria are different. The processor is programmed to transform the first criterion into first data of a third criterion, transform the second criterion into second data of the third criterion, compare the first and second data of the third criterion and flag a match between the two entities if the first and second data of the third criteria match.

### FIELD OF THE INVENTION

The present invention relates to a retail contract matching system. In particular, the system relates to an automated exchange for trading financial products.

### BACKGROUND

Online networks and computer penetration have allowed the development of automated exchanges for the trading of goods and services between sellers and buyers.

These exchanges can adopt many different mechanisms for matching parties in a trade, from auctions to order-driven exchanges.

This approach can be used to trade financial products. While commercial entities such as stock and futures exchanges have long relied on electronic methods to match buyers and sellers efficiently, this has only recently started to happen for retail (consumer) markets in which consumers contract directly with other consumers (referred to as peer-to-peer or person-to-person).

Three main challenges exist to the use of automated exchanges to financial products:
Credit Risk: managing the risk associated with extending credit to an individual;
Matching process:
   1. Finding an effective method to match parties to a contract where the underlying matching attribute (for instance nominal interest rate) is expressed differently to both parties (e.g. the actual interest rate paid by the borrower versus the actual return received by the lender) for practical or regulatory reasons.
   2. Finding an effective way of matching lenders and borrowers who want to commit for different terms; and
Rate setting: devising a mechanism to determine the rate at which transactions should take place.

### Credit Risk

Credit risk is normally handled by lending institutions such as banks through the bank becoming a counter party to the transaction—lenders lend to the bank and the bank lends to borrowers.

The bank sets the rate the borrower pays based on its assessment of the risk of default and the bank assumes the risk in this case. Individual lenders are protected from default because they do not contract directly with a lender.

Consumer financial exchanges work in the main by matching borrowers directly with lenders (there may be one or more lender or borrower on either side of a trade). This means that the lender is exposed directly to any default by the borrower.

Therefore any such exchange must put in place a mechanism to manage this risk.

### Matching Process

1. Interest rates on loans are expressed as nominal rates and real rates.
The nominal rate is the rate of the loan before any charges or fees or adjustments due to timing of repayments have been applied. Real rates express the actual effective rate the borrower pays or lender receives once fees and payment terms have been considered.
In many countries the display of such information to consumers is controlled by regulation. For instance in the UK the Annualized Percentage Rate (APR) is a defined measure designed to allow borrowers to compare financial products by having the interest and fees expressed as a standard yearly rate.

Thus the real rate of a loan at a given nominal rate will be different for the borrower and the saver, and may be different for different savers or borrowers depending on how credit risk and charges are calculated.

This need to represent rates in a consumer-friendly manner presents a challenge to interactive exchanges that need to match orders based on an underlying rate. The determination of APR in particular is a complex calculation that incorporates the nominal rate, any fees and the relevant time period. The calculation is almost always carried out by advanced financial software. Consumers therefore cannot be expected to readily translate in their mind a nominal rate to the APR.

Thus there is a major difficulty in creating a transparent exchange mechanism that allows both lenders and borrowers (for instance in the case of a loan exchange) to view and input requests to lend or borrow at rates that are real to them.

2. Lenders wish to commit their funds for varying lengths of time. Similarly, borrowers have their own time horizon: some want to borrow for a short period of time, others for a longer period.

Finding exact matches for these different requirements can be restrictive because at times there are not exact matches. However, when aggregate lender supply is considered over the course of a loan term, it is possible to find a sequence of matches.

This need to provide both lenders and borrowers with consistent counterparties is a challenge in the peer to peer model where there is not a central counterparty that can transform liquidity from short to long and vice versa, taking up any slack in the middle. With the existing peer to peer model, only matches with exactly the same terms are matched which can cause inefficiency.

### Rate Setting

In a true market exchange, prices are determined by the aggregate actions of the participants in the market. But due in part to the above two complications, creating a dynamic, liquid and efficient marketplace for consumer financial products has proven difficult.

These complications have hampered the growth of financial exchanges aimed at consumers and the liquidity of these exchanges.

### STATE OF THE ART

### Credit Risk

A number of approaches have been devised by the person-to-person industry to handle the risk of consumers lending to consumers.

In one case all orders from lenders are matched with a fixed number of borrowers. The number chosen is designed to produce a degree of risk spreading in the case of a borrower default. However this also has the effect of impeding the matching process (and hence reducing the liquidity of the market).

Another approach is to group borrowers in credit bands. Borrowers in each band pay a rate of return linked to their credit risk and lenders select which band they want to lend to.

Alternatively borrowers can have individual credit scores applied and lenders are invited to select which borrower they want to lend to. This again reduces liquidity and requires lenders to make credit decisions about individuals, which they may not feel qualified to do. Any of these approaches can be used together.

### Matching Process

1. The manner in which orders are matched is typically linked to the credit risk handling adopted by the exchange.

For instance where the exchange assigns a credit rating to the borrower, matching is simply a matter of the lender deciding to accept the loan request. Of course tools can be provided to automatically identify matching loans based on the lender's preferences, but the lender still needs to review and accept the actual borrower.

In an auction based model (see below) the match is determined by the winning bid.

Some models adopt a one-way matching process in which lenders, say, provide the rate at which they are willing to lend and the borrowers can either accept or reject this. This is more dynamic than an auction but reduces the visibility of demand from both sides as only one set of prices is listed.

2. All existing peer to peer models match term lender commitments with term loans.

### Rate Setting

The mechanism whereby the rates at which loans trade is normally a function of a combination of the credit rating and matching processes adopted by the exchange.

For instance in an auction model one party (say, the borrower) indicates the highest rate they are prepared to accept and the lenders then bid to take the loan. The lowest bid within the auction time period gets the loan. This approach prevents a true dynamic two-way market and requires a defined time period (the auction window) before a rate can be set.

Where one party sets a rate for the other side to accept or reject, the exchange is not two-way as the pricing information is only available from one side of the contract.

Another model removed the ability of participants to set rates. Instead the exchange applies a calculated rate to the borrower request and the lender is able to select a loan that meets their own requirements.

Another method scores potential borrowers and puts them into pre-designated credit groups. Lenders can then choose which group they wish to lend to.

Alternatively borrowers and lenders interact with the exchange using nominal rates. Participants only see the “real” rate when a contract is created and the appropriate fees are calculated. This has the disadvantage that the rate offered can be significantly different to the rate achieved, which can result in orders being cancelled.

All of these approaches are trying to address issues of credit worthiness, the matching process and rate setting by these means in part because they have failed to develop machinery to deliver a liquid, transparent market in the optimal way.

### OBJECT OF THE INVENTION

It is the object of the present invention to overcome one or more of the above described disadvantages, or at least to provide a useful alternative.

### SUMMARY OF THE INVENTION

In a first aspect the present invention provides a matching mechanism for matching entities in an exchange, the entities being based on disparate criteria, the mechanism comprising:

a first input from a first set of users adapted to submit to a processor a first criterion from a first set of criteria relevant to the first set of users, which first criterion characterises an entity to be matched;

a second input from a second set of users adapted to submit to the processor a second criterion from a second set of criteria relevant to the second set of users, which second criterion characterises another entity to be matched, wherein the first and second criteria are different;
wherein the processor is programmed to:

(i) transform the first criterion into first data of a third criterion;

(ii) transform the second criterion into second data of the third criterion;

(iii) compare the first and second data of the third criterion; and

(iv) flag a match between the two entities if the first and second data of the third criteria match.

Preferably the first set of criteria are rates relevant to a user in the first set of users.

The rates relevant to a user in the first set of users are preferably real rates of return.

The second set of criteria are preferably rates relevant to a user in the second set of users.

The rates relevant to a user in the second set of users are preferably a real cost of borrowing.

The first and second data of the third criteria are preferably nominal interest rates, thereby allowing matching of entities at nominal interest rates.

The entities are preferably contracts, the first set of users are potentially a party lending in the contract and the second set of users are potentially a party borrowing in the contract, thereby allowing matching of contracts based on disparate criteria.

There is preferably a pooled fund derived from individual borrower contributions thereby spreading a risk associated with lending to the second set of users across all contracts in the exchange.

The processor is preferably operable to manipulate first and second criteria by calculating nominal interest rates from real returns or real costs of borrowing.

The calculation of a nominal interest rate preferably incorporates a variable representing a borrower's credit rating.

The variable is preferably a calculation of a borrower's credit rate from a credit rating.

The calculation preferably gives a credit rate to a borrower based on their credit rating.

The calculation preferably incorporates a variable to reflect aggregated amounts paid into a fund to provide recompense to lenders in the event of a borrower default where the borrower and the lender are both users.

The exchange further preferably provides a facility to view entities in the exchange expressed in terms of the first and second data of the third criteria.

The matching mechanism in combination with an entity exchange, wherein the exchange preferably further provides a facility to view entities placed in the exchange in terms of the first and second data of the third criteria in terms of the first and/or second criteria.

The facility preferably allows a participant to view orders in the exchange placed at nominal rates but expressed as real interest rates.

The facility preferably allows a participant to view orders in the exchange placed at nominal rates but expressed as real interest rates particular to a user.

The mechanism preferably allows a user to place an order at a real interest rate which will then be calculated as a nominal rate for matching on the exchange.

In a second aspect, the present invention provides a pricing engine for use in an exchange trading entities based on disparate criteria, the pricing engine being operable to manipulate a first criterion price and arrive at a third criterion price and to manipulate a second criterion price and arrive at a third criterion price.

The matching mechanism is preferably adapted to create loans of a defined term and rate from a set of opposing contracts with different terms and rates.

The matching mechanism is preferably adapted to allow for the changing or setting of rates with a matching re-positioning of the contracts to achieve an overall blended rate.

In a third aspect, the present invention provides a loan facilitation system comprising:

a first computer processor adapted to receive input data from a first user, the input data identifying credit criteria about the first user;

a second computer processor adapted to receive input data from a second user, the input data identifying lending criteria about the second user;

a third computer processor in remote communication with the first computer processor and adapted to receive and store the credit criteria and lending criteria;

wherein the third computer processor is adapted to

(i) transform the credit criteria into first data of a common criteria;

(ii) transform the lending criteria into second data of the common criteria;

(iii) compare the first and second data of the common criteria; and

(iv) flag a match between the first and second users if the first and second data of the common criteria match.

The first and second data of the third criteria preferably include interest rate values, and the third computer processor is preferably adapted to communicate a match to the first computer processor and the second computer processor.

The loan facilitation system preferably includes a plurality of first computer processors and a plurality of second computer processors, wherein a loan may be matched between one or more of the first users and one or more of the second users.

The third computer processor is preferably adapted to obtain credit history information regarding the first user from a third party, further wherein the third computer processor is adapted calculate a risk profile and lending limit of the first user.

### BRIEF DESCRIPTION OF THE DRAWINGS

In order that the present invention may be more readily understood, embodiments thereof will now be described, by way of example, with reference to the accompanying drawings, in which:

FIG. 1 is a block diagram illustrating hardware elements of an exchange incorporating a matching mechanism embodying the present invention;

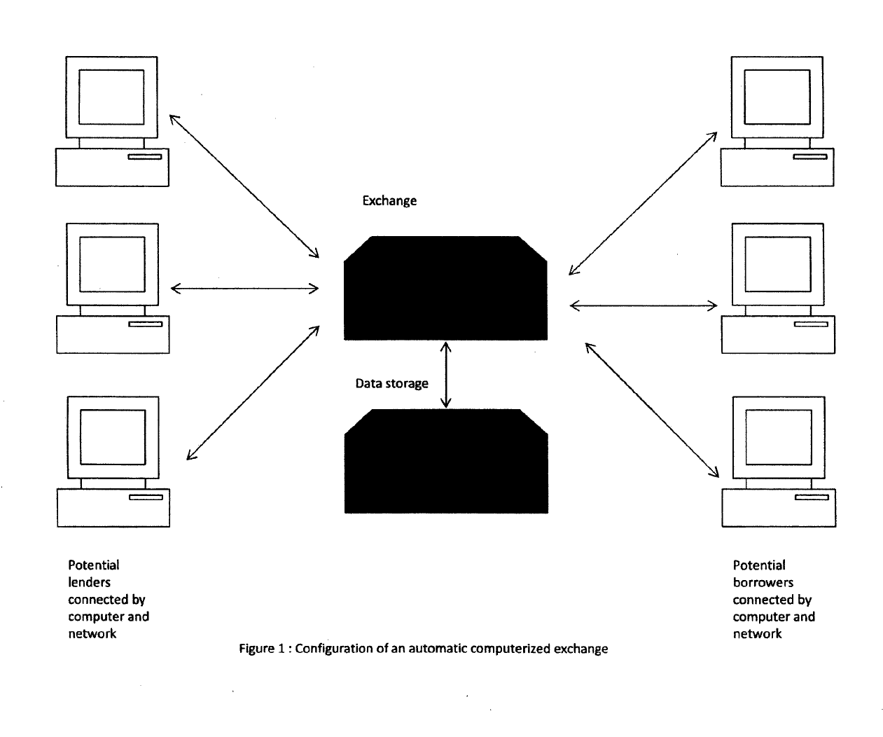

FIG. 2 is a block diagram showing elements of the exchange, including a matching mechanism embodying the present invention;

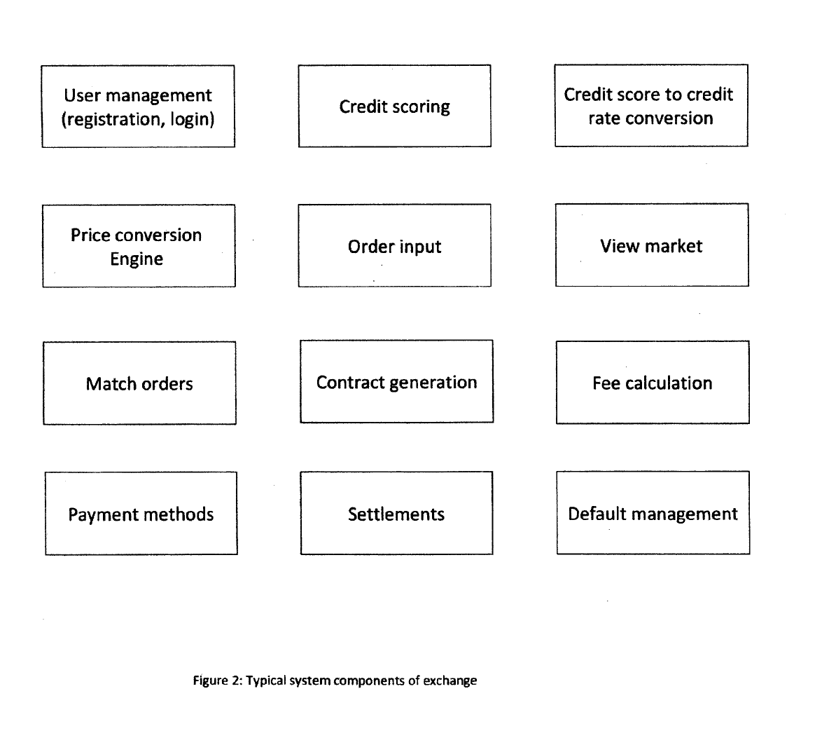

FIG. 3 is a block diagram illustrating an exchange including a matching mechanism embodying the present invention incorporating or having access to a price conversion engine;

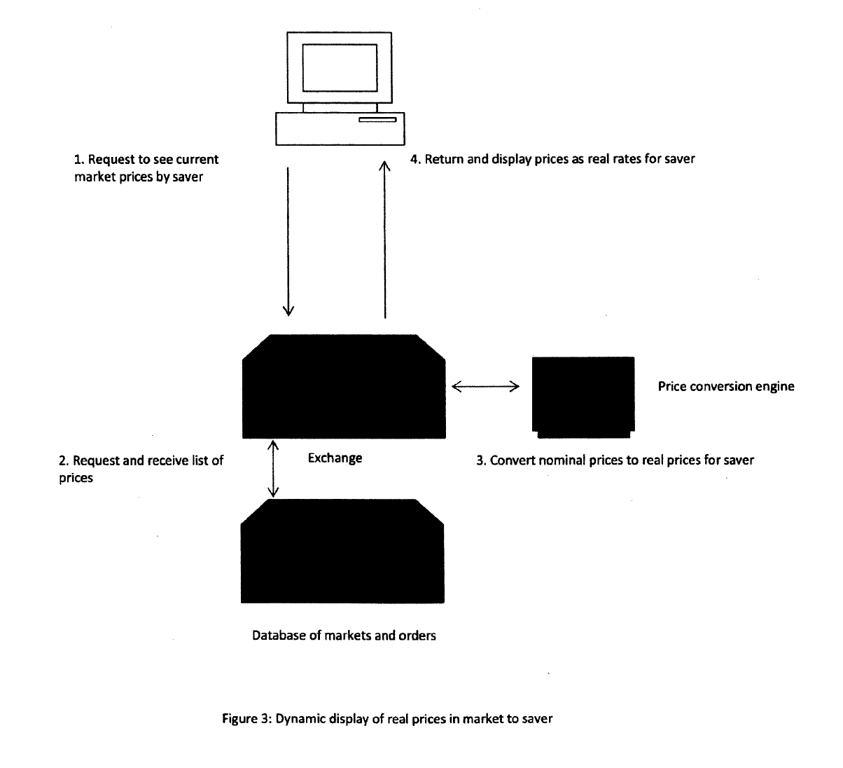

FIG. 4 is a block diagram illustrating an exchange including a matching mechanism embodying the present invention incorporating or having access to a price conversion engine;

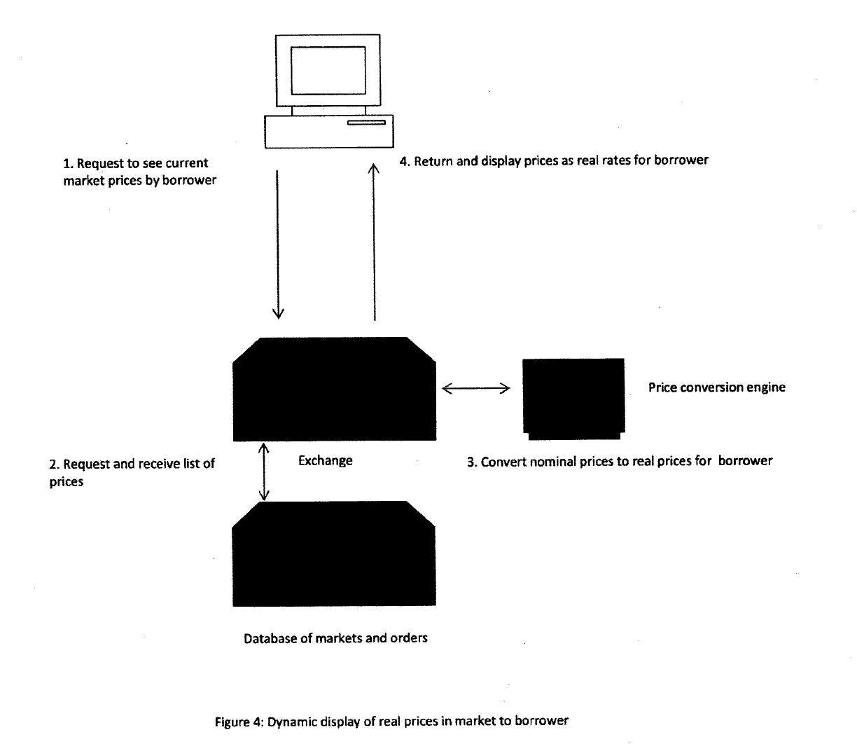

FIG. 5 is a flow chart for calculating a credit rate for use in the price conversion engine or matching mechanism embodying the present invention;

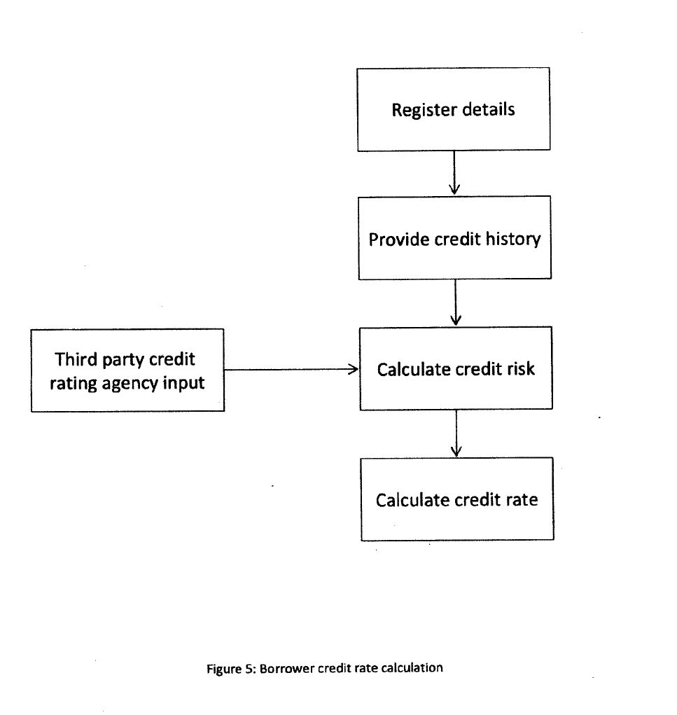

FIG. 6 is a flow diagram illustrating user interaction with an exchange incorporating a matching mechanism embodying the present invention;

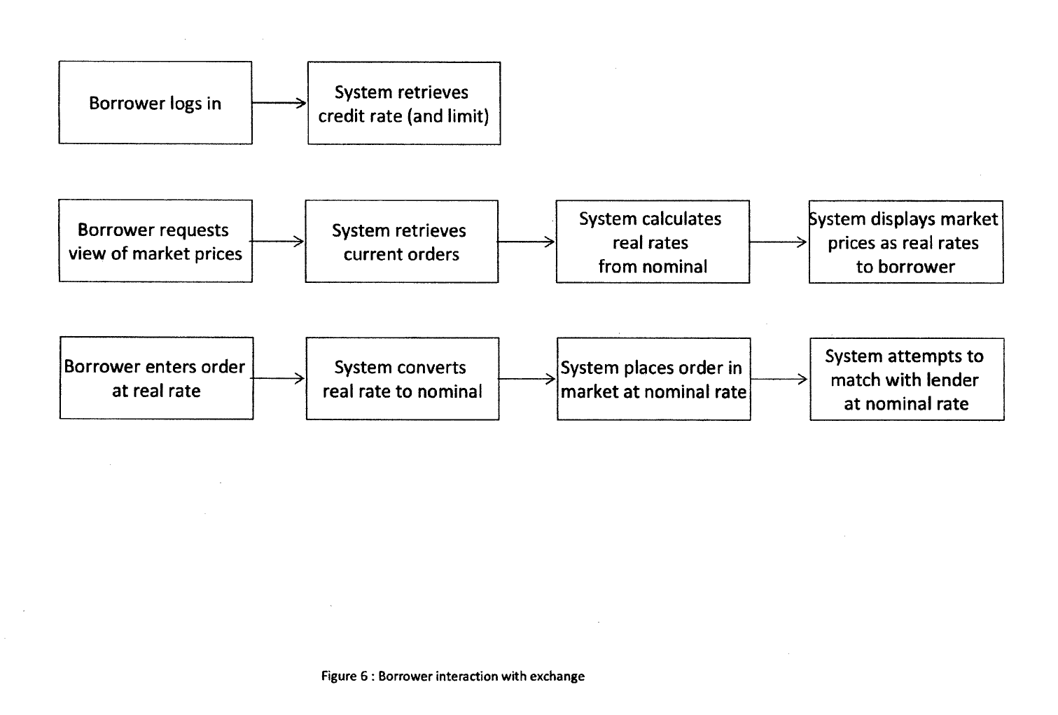

FIG. 7 is a flow diagram illustrating another user interaction with an exchange incorporating a matching mechanism embodying the present invention; and

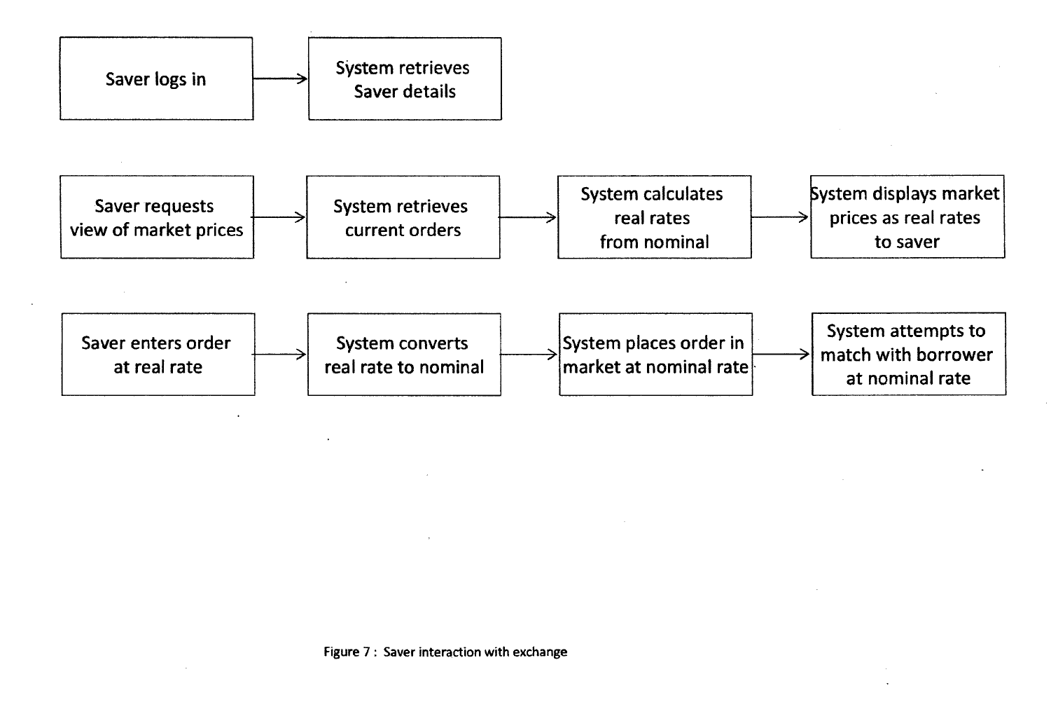

FIG. 8 is a block diagram and flow chart of an exchange incorporating a matching mechanism embodying the present invention and price conversion engine embodying the present invention and an exemplary workflow.

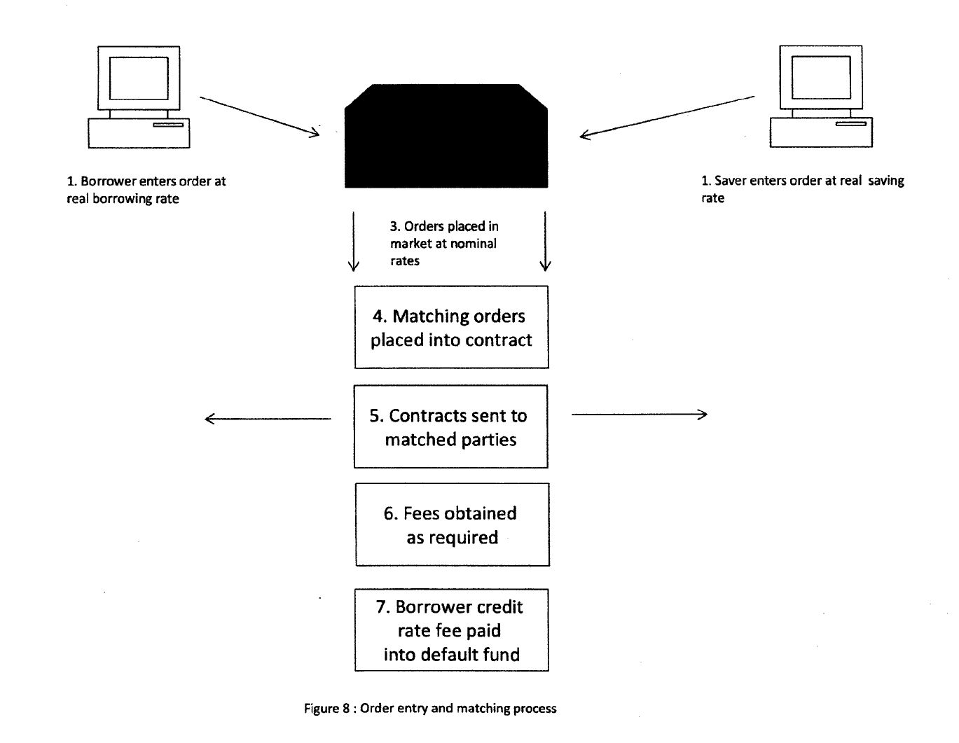

### DETAILED DESCRIPTION OF THE PREFERRED EMBODIMENTS

One aspect of the invention provides a matching mechanism for matching entities in an exchange, the entities being based on disparate criteria, the mechanism comprising:

a first input from a first set of users adapted to submit to a processor a first criterion from a first set of criteria relevant to the first set of users, which first criterion characterises an entity to be matched;

a second input from a second set of users adapted to submit to the processor a second criterion from a second set of criteria relevant to the second set of users, which second criterion characterises another entity to be matched, wherein the first and second criteria are different;
wherein the processor is programmed to:

(I) transform the first criterion into first data of a third criterion;

(ii) transform the second criterion into second data of the third criterion;

(iii) compare the first and second data of the third criterion; and

(iv) flag a match between the two entities if the first and second data of the third criteria match.

Another aspect of the invention provides a pricing engine for use in exchange trading entities based on disparate criteria, the pricing engine being operable to manipulate a first criterion price and arrive at a third criterion price and to manipulate a second criterion price and arrive at a third criterion price.

A further aspect of the invention provides an exchange incorporating a pricing engine and/or a matching mechanism.

Examples of the invention deliver an exchange incorporating a matching mechanism and/or a pricing engine.

In one embodiment a genuine two way market for consumer financial products is enabled. Embodiments address issues relating to credit risk, matching and rate setting by exposing each aspect to the consumer in a clear and transparent manner.

Embodiments allow borrowers and lenders to interact with the exchange using “real” interest rates tailored to each participant's situation, while still maintaining a transparent matching process based on nominal rates.

The exchange contains a mechanism to back calculate nominal rates based on borrowers' effective real interest rate (APR) and lenders' real return.

The nature of the calculation of the nominal contract rate from the quoted real rate will depend on the exact nature of the loan (its repayment rules etc.). By way of an example consider a loan in which the lender is charged a fee of 10% of the interest by the exchange for the management of the loan. In this case the nominal rate (N) is calculated by dividing the real rate (R) by 1.1. In general in this case the calculation can be expressed as:

N=R/(1+I) where I is the interest charge expressed as a decimal value.

In other cases the calculation may be more complex. Consider the case where a borrower is charged both a percentage of the loan and a fixed fee as charges.

To calculate the real rate depends on the fees, their timing (are they paid at the end or the beginning of the loan), the nominal interest rate and the amount borrowed. Real rates are often expressed as an annual equivalent rate to allow different loans to be compared. Finding the real rate in this case requires the solution to the problem that includes the solution as the input. Such an equation can be solved using iterative techniques such as the Newton Rapheson Method of Successive Approximation.

To return the nominal rate from the real rate requires as input the loan amount and the amount and timing of any repayments and fees.

As an example, consider a loan which is subject to a single repayment at the end of the term which includes the capital, fees and interest due. In this case the nominal interest is calculated from the following equation:

L=(L+F+I)/(1+A)̂x
where L is the loan amount received, F is the fee, I is the interest (both paid at the end of the term) A is the real rate of interest and x is the term expressed as a fraction of 1 year (i.e if the loan is for 1 month x=1/12).

This can solved for any given loan, fee and real rate to provide the nominal interest rate (expressed as a fraction) as:

N=(I/L[(1+A)̂X]−L−F)*100

In the case of a sequence of regular payments (e.g. an amortizing loan) the calculation of the nominal rate from the real rate can be calculated as follows:

$$L = R ( {\sum }_{n = 1}^{n = t} 1 / ( {A}^{⋀} ( t / y ) ) )$$

Where L is the loan amount received, R is the fixed monthly repayment, A is the real rate, t is the number of terms and y is the duration of the term (in fractions of a year, e.g. 12 for a month)

The term in the summation can be calculated (as S); then the monthly repayment R can be found as L/S. The nominal interest due (D) can then be calculated as (R*t)/L from which the nominal interest rate can be obtained as I=D/L adjusted for the term of the loan as a fraction of a year.

These rates may be the same for each borrower and each lender, or may be specific to each participant, depending on how credit risk is handled.

The exchange contains a mechanism to allow the calculation of each individual borrower's credit rating.

For instance the exchange can obtain credit history information about the borrower from third party credit agencies. This information combined with any other information obtained directly from the borrower can be used to determine a weighted credit score. The particulars of the weighting will most likely depend on current economic conditions which determine overall credit risk.

The exchange contains a mechanism to assign an APR to a borrower based on their credit rating.

For example if the borrower APR is used as a mechanism to create funds for protection of lenders from default by borrowers, the APR will be calculated to ensure that the amounts generated by the APR will be sufficient to cover the anticipated default rate for borrowers with that credit rating.

The borrower APR can be used to adjust the rate paid by a borrower for a loan to reflect the credit risk associated with lending to them.

The exchange could possibly use the extra payments generated by the borrower APR to create a fund that can be used to reimburse lenders in the event of a default, allowing for the risk to be spread across all loans.

The exchange can then present to the borrower a view of the market showing all orders from both lenders and borrowers expressed as an APR relevant to their credit score—i.e. different borrowers will see the same order as a different APR as the rate is adjusted according to their individual credit rate.

Alternatively all borrowers could pay the same risk premium or the borrowers could be placed into risk categories with a different APR applied to each category. Savers would then choose which class of borrower they want to lend to.

Additionally savers could voluntarily choose to pay into a fund that provides protection against default. In this case the return shown would be adjusted for each lender based on their decision to contribute (or the amount of contribution chosen) or not. This mechanism could be instead of or in addition to the borrower paying a credit rate premium.

Similarly lenders can see the same orders expressed as a real return depending on the fees they would need to see.

In both cases the exchange “back calculates” from the APR and the lender return to the required nominal rate. The exchange would then match lenders and borrowers based on this nominal rate.

This design allows for a number of transparent credit risk handling strategies, such as:
1. Lenders can indicate the maximum borrower credit rate that they are willing to accept. The service would only then match them with borrowers who meet this criteria. This has the effect of reducing the overall liquidity of the exchange.
2. The additional costs paid by the borrower represented by the credit rate could be paid into a fund. This fund could be used to reimburse lenders suffering default. This mechanism allows for the risk to be spread across all lenders and does not reduce the liquidity of the exchange (as lenders can be matched with any borrower regardless of their credit rate).
3. The premium paid by the borrower could be used to purchase protection against default for the lender.

Regardless of the mechanism chosen, the invention allows both parties to place orders to lend or borrow as real rates. These rates are translated into the required nominal rate. The nominal rate is then used to match orders based on the particular rules required by the exchange.

Embodiments of this matching engine provide the ability to show lenders and borrowers different real rates but match them all at a nominal rate. This technology allows for cross-jurisdictional rate matching, i.e. a lender in one country might see a different lender return to a lender in another country because of different operating parameters in the respective jurisdictions or countries.

In the case where borrowers are assigned a credit rate which is used to create a fund to recompense lenders in the event of default, a lender can be matched with ANY borrower regardless of the borrower's credit rating as the match will take place at the underlying nominal rate, and the risk handling is provided by the fund, thereby “equalizing” the risk of each borrower.

In this implementation the exchange can rapidly achieve greater liquidity than any existing implementation as the handling of risk in these cases typically serves to reduce liquidity by splitting borrowers based on credit rating.

By way of an example the matching mechanism and pricing engine are configured in the exchange as an Internet based consumer loans exchange. In the exchange borrowers and lenders can enter requests, orders or contracts to borrow or lend money at an APR or return of their choosing, i.e. in accordance with one set of criteria of the users choosing (or defined by the user's profile on the system).

Anyone wishing to borrow money must first provide details of their credit history. This information is used (possibly in conjunction with third party credit checking services) to determine a credit risk for the borrower. The total cost of borrowing (the nominal rate plus the credit rate plus any fee) is then expressed as an APR (e.g. 9%).

This will be calculated as the APR due to the nominal rate and the fee, to which is then added the borrower credit rate to get the overall APR. Calculation of the APR from the nominal rate and fee will depend on the rules governing calculation of APRs prevalent to the exchange. For instance in the UK the APR for consumer borrowers is defined by regulation. In this case the exchange will calculate the APR from the loan amount, fees and re-payment schedule as defined by regulation. The borrower APR is then added to this APR to get the total cost of borrowing.

When a borrower wishes to place a request for a loan, they can enter the APR they would like to achieve. The exchange will then calculate the required nominal rate that would give rise to this requested APR based on any fees, the loan details (amount and repayments) and the borrower's individual credit rate.

The borrower can also see the current state of the market through the exchange. This will show current outstanding borrower and loan requests expressed in APR values adjusted for that borrower. This will allow the borrower to determine which rate they should select.

In this particular case the additional amount paid by the borrower through the Credit Rate is pooled into a fund. This fund is used to reimburse lenders suffering default. The precise details of the fund and the manner in which it makes repayments may be subject to the local regulatory environment.

Any lender can view the market and see requests from borrowers (and other lenders). These requests are expressed as real return based on the fees paid by savers and the loan details (amount, duration, repayments etc.). In this case all savers will see the same return for a given nominal order rate.

When an order is placed in the market the match will take place at the nominal rate and be flagged by the system so that a mutual contract can then be entered into by the parties.

Under the liquidity transformation proposed, a lender who wants to lend his money for say 1 year for a fixed amount receiving interest only every month could be matched for that period with a borrower who is looking to borrow for a longer period with this lender's source of funds just being part of the funding for that relevant period.

In the proposed solution a way of mixing the different term requirements of lenders and borrowers is proposed. The system will match a series of payments from the borrower (effectively a repayment plan) over their desired term with the necessary source of funds from lenders who have committed for various different terms. This will result in the peer to peer loan having the mixed cost of funds typical of the traditional bank loan which is funded by bank deposits committed for various terms. The proposed solution will deliver lenders consistent counterparties while delivering borrowers a blended cost of funds (likely to be lower). Rather than the loan having potentially one match over the exact term the proposed solution will match the loan to multiple lender terms. The apportionment will be determined by liquidity guidelines set down for the exchange to follow.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1.-26. (canceled)

27. A matching mechanism for matching entities in an exchange, the entities being based on disparate criteria, the mechanism comprising:
a first input from a first set of users adapted to submit to a processor a first criterion from a first set of criteria relevant to the first set of users, which first criterion characterizes an entity to be matched;
a second input from a second set of users adapted to submit to the processor a second criterion from a second set of criteria relevant to the second set of users, which second criterion characterizes another entity to be matched, wherein the first and second criteria are different;
wherein the processor is programmed to:
(i) transform the first criterion into first data of a third criterion;
(ii) transform the second criterion into second data of the third criterion;
(iii) compare the first and second data of the third criterion; and
(iv) flag a match between the two entities if the first and second data of the third criteria match.

28. The matching mechanism according to claim 27, wherein the first set of criteria are rates relevant to a user in the first set of users.

29. The matching mechanism according to claim 28, wherein the rates relevant to a user in the first set of users are real rates of return.

30. The matching mechanism according to claim 27, wherein the second set of criteria are rates relevant to a user in the second set of users.

31. The matching mechanism according to claim 30, wherein the rates relevant to a user in the second set of users are a real cost of borrowing.

32. The matching mechanism according to claim 27, wherein the first and second data of the third criteria are nominal interest rates, thereby allowing matching of entities at nominal interest rates.

33. The matching mechanism according to claim 27, Wherein the entities are contracts, the first set of users are potentially a party lending in the contract and the second set of users are potentially a party borrowing in the contract, thereby allowing matching of contracts based on disparate criteria.

34. The matching mechanism according to claim 33, wherein there is a pooled fund derived from individual borrower contributions thereby spreading a risk associated with lending to the second set of users across all contracts in the exchange.

35. The matching mechanism according to claim 27, wherein the processor is operable to manipulate first and second criteria by calculating nominal interest rates from real returns or real costs of borrowing.

36. The matching mechanism according to claim 35, wherein the calculation of a nominal interest rate incorporates a variable representing a borrower's credit rating.

37. The matching mechanism according to claim 36, Wherein the variable is a calculation of a borrower's credit rate from a credit rating.

38. The matching mechanism according to claim 37, wherein the calculation gives a credit rate to a borrower based on their credit rating.

39. The matching mechanism according to claim 27, wherein the calculation incorporates a variable to reflect aggregated amounts paid into a fund to provide recompense to lenders in the event of a borrower default where the borrower and the lender are both users.

40. The matching mechanism according to claim 27 in combination with an entity exchange, wherein the exchange further provides a facility to view entities in the exchange expressed in terms of the first and second data of the third criteria.

41. The matching mechanism according to claim 27 in combination with an entity exchange, wherein the exchange further provides a facility to view entities placed in the exchange in terms of the first and second data of the third criteria in terms of the first and/or second criteria.

42. The matching mechanism according to claim 41, wherein the facility allows a participant to view orders in the exchange placed at nominal rates but expressed as real interest rates.

43. The matching mechanism according to claim 42, wherein the facility allows a participant to view orders in the exchange placed at nominal rates but expressed as real interest rates particular to a user.

44. The matching mechanism according to claim 27, wherein the mechanism allows a user to place an order at a real interest rate which will then be calculated as a nominal rate for matching on the exchange.

45. The matching mechanism of claim 27 adapted to create loans of a defined term and rate from a set of opposing contracts with different terms and rates.

46. The matching mechanism of claims 27 adapted to allow for the changing or setting of rates with a matching re-positioning of the contracts to achieve an overall blended rate,

47. An exchange including a matching mechanism according to claim 27.

48. A pricing engine for use in an exchange trading entities based on disparate criteria, the pricing engine being operable to transform a first criterion price and arrive at a third criterion price and to transform a second criterion price and arrive at a third criterion price.

49. An exchange including a pricing engine according to claim 48.

50. A loan facilitation system comprising:
a first computer processor adapted to receive input data from a first user, the input data identifying credit criteria about the first user;
a second computer processor adapted to receive input data from a second user, the input data identifying lending criteria about the second user;
a third computer processor in remote communication with the first computer processor and adapted to receive and store the credit criteria and lending criteria;
wherein the third computer processor is adapted to
(i) transform the credit criteria into first data of a common criteria;
(ii) transform the lending criteria into second data of the common criteria;
(iii) compare the first and second data of the common criteria; and
(iv) flag a match between the first and second users if the first and second data of the common criteria match.

51. The loan facilitation system of claim 50, wherein the first and second data of the common criteria include interest rate values, and the third computer processor is adapted to communicate a match to the first computer processor and the second computer processor.

52. The loan facilitation system of either of claims 51, including a plurality of first computer processors and a plurality of second computer processors, wherein a loan may be matched between one or more of the first users and one or more of the second users.

53. The loan facilitation system of any one of claims 52, wherein the third computer processor is adapted to obtain credit history information regarding the first user from a third party, further wherein the third computer processor is adapted to calculate a risk profile and lending limit of the first user.
